(19) United States
(12) Patent Application Publication
(10) Pub. No.: US 2019/0039917 A1
(43) Pub. Date: Feb. 7, 2019

(54) WATER PROCESSING DEVICE

(71) Applicant: Pall Corporation, Port Washington, NY (US)

(72) Inventors: Christian DAHLBERG, Bempflingen (DE); Steffen KEY, Magstadt (DE); Dietmar OECHSLE, Schwabisch Gmund (DE)

(21) Appl. No.: 16/157,360

(22) Filed: Oct. 11, 2018

Related U.S. Application Data
(63) Continuation of application No. PCT/EP2017/059549, filed on Apr. 21, 2017.

(30) Foreign Application Priority Data
Apr. 22, 2016 (DE) 102016107485.3

(51) Int. Cl. C02F 1/28; C02F 1/42; B01D 69/08; C02F 1/44; B01J 20/12; B01J 20/20; B01J 20/26; B01J 20/22; B01J 20/02; B01J 47/014

(52) U.S. Cl. CPC C02F 1/283; C02F 2101/20; C02F 1/285; C02F 1/42; B01D 69/08; C02F 1/44; B01J 20/12; B01J 20/20; B01J 20/26; B01J 20/22; B01J 20/02; B01J 47/014; C02F 2201/006; C02F 2001/422; C02F 2001/425; C02F 1/281

(57) ABSTRACT

A water processing device is provided for removing micro-pollutants, in particular medicaments, from water, the device comprising at least one housing and at least one adsorption unit which is arranged in the housing and which at least partially adsorbs the micro-pollutants in at least one operating state and which comprises at least one non-specific adsorption element, wherein the at least one adsorption unit comprises at least one specific adsorption element.

### CROSS-REFERENCE TO RELATED APPLICATIONS

This patent application is a Continuation of International Patent Application No. PCT/EP2017/059549, filed Apr. 21, 2017, which claims the benefit of German Patent Application No. 10 2016 107 485.3, filed Apr. 22, 2016, which are each incorporated by reference.

### BACKGROUND OF THE INVENTION

The invention relates to a water processing device according to the preamble of claim 1.

Water processing devices which use adsorption units comprising non-specific adsorption elements in order to process water so as to remove pollutants have already been proposed. Whereas processing efficiency is sufficient for most of the pollutants contained in the water, the processing efficiency of water processing devices of this kind in respect of micro-pollutants is significantly reduced, since these pollutants on the one hand are present in a much lower concentration and on the other hand have at least substantially lower molecular weights. Although the concentrations of the individual micro-pollutants usually lie below the critical tolerance limits for the environment and humans, the sum parameter of the various micro-pollutants is not taken into consideration. In particular, certain micro-pollutants are selectively removed only insufficiently. It is therefore of interest to remove these pollutants from water with increased efficiency.

### BRIEF SUMMARY OF THE INVENTION

The object of the invention is in particular to provide a device of this kind having improved properties in respect of its efficiency, in particular processing efficiency. The object is achieved in accordance with the invention by the features of claim 1, whereas advantageous embodiments and developments of the invention can be derived from the dependent claims.

The invention relates to a water processing device which is provided for removing micro-pollutants, in particular medicaments, from water, in particular drinking water, said device comprising at least one housing and comprising at least one adsorption unit, which is arranged in the housing and which at least partially adsorbs the micro-pollutants in at least one operating state, and which comprises at least one non-specific adsorption element.

It is proposed that the adsorption unit comprises at least one specific adsorption element. In particular, the water processing device can additionally comprise a filter unit. The efficiency, in particular processing efficiency, can be improved as a result. In particular, the quality of the water processing can be increased. Water advantageously can also be processed selectively in respect of specific micro-pollutants.

The term “provided” shall be understood here in particular to mean specially designed and/or equipped. The fact that an object is provided for a specific function shall be understood in particular to mean that the object fulfils and/or carries out this specific function in at least one application and/or operating state. A “water processing device” shall be understood in particular to mean a device which is provided for processing, purifying, clarifying, cleaning and/or purging water, in particular drinking water, and advantageously for removing micro-pollutants, in particular in that these are filtered and/or sorbed from the water, in particular absorbed and/or particularly preferably adsorbed. The water processing device is in particular at least a part, in particular a subassembly, of a water processing cartridge, a system for water processing and/or a water processing plant, such as a sewage treatment plant. In particular, the water processing device can fully comprise the water processing cartridge, the system for water processing and/or the water processing plant. In particular, the water processing device can be connected, advantageously directly, to a domestic water supply, preferably to a water tap, and in particular is arranged upstream thereof in respect of the flow direction. An “operating state” of the water processing device shall be understood in particular to mean a state in which water is flowed through the water processing device fully.

The term “micro-pollutants” shall be understood in particular to mean pollutants such as industrial chemicals, medicaments, in particular carbamazepine, sulfamethoxazole, diclofenac and/or ethinylestradiol, heavy metals and/or pesticides, which are present in the water, in particular dissolved therein, in a low concentration, more specifically in particular in a concentration of less than 10,000 ppm, preferably less than 1000 ppm, more preferably less than 100 ppm, and particularly preferably less than 10 ppm. In particular, the micro-pollutants have a molecular weight of less than 100 kDa, preferably less than 10 kDa, more preferably less than 1 kDa, and particularly preferably less than 0.1 kDa.

An “adsorption unit” shall be understood in particular to mean a unit having at least one adsorption element, which is provided for at least substantially securely binding and/or adsorbing a micro-pollutant, in particular a dissolved micro-pollutant, in particular by means of at least one adsorbent, preferably a plurality of adsorbents, more specifically in particular on a surface, preferably in a cavity, and particularly preferably in a pore of the adsorbent. In particular, the underlying adsorption mechanism for binding the micro-pollutants is different from a covalent bonding. The adsorption element is advantageously provided for at least substantially securely binding the micro-pollutants by means of the Coulomb and/or van der Waals interaction. The expression “at least substantially securely binding a micro-pollutant” shall be understood in particular to mean that an adsorbed micro-pollutant is washed out in a wash-out test by means of flushing with water within a period of time of at least one hour, advantageously at least two hours, and preferably at least four hours, to an extent of at most one percent, advantageously at most half a percent, and preferably at most a tenth of a percent of a bound substance quantity. The adsorption unit is in particular at least partially chemically regenerable. The term “chemically regenerable” shall be understood in particular to mean that the at least one adsorbent can be regenerated by means of a chemical reaction. In particular, the adsorbent can be chemically regenerated by means of an acid and/or a lye, preferably sodium hydroxide. The adsorbent is also chemically regenerable in particular by means of a saline solution, preferably a NaCl solution. Alternatively or additionally, the adsorbent can be regenerated in particular by being exposed to energy, for example in the form of heat and/or electromagnetic radiation, in particular by being exposed to light, preferably UV light. The adsorption unit is formed in particular as an advantageously water-permeable solid block or as a fill, which block/fill is formed at least in part by at least one adsorption element.

A “non-specific adsorption element” shall be understood in particular to mean an adsorption element which comprises at least one non-specific adsorbent, which is provided for adsorbing a plurality of micro-pollutants chemically non-specifically, in particular to the same extent and preferably independently of functional groups of the micro-pollutants and/or a charge of the micro-pollutants. The non-specific adsorbent is provided in particular for adsorbing various micro-pollutants in a sterically dependent manner. The non-specific adsorption element can advantageously comprise a plurality of non-specific adsorbents. A “specific adsorption element” shall be understood in particular to mean an adsorption element which comprises at least one specific adsorbent, which is provided for adsorbing specific micro-pollutants in a chemically or physically specific manner, in particular to a different extent and preferably depending on functional groups of the micro-pollutants and/or a charge of the micro-pollutants. The specific adsorbent is provided in particular for adsorbing certain micro-pollutants sterically independently. The specific adsorption element can advantageously comprise a plurality of adsorbents.

Alternatively or additionally, the adsorption unit can be formed at least partially in one piece with a further body, for example the filter unit, more specifically advantageously in the form of an impregnation and/or coating. The expression “formed at least partially in one piece” shall be understood in this context in particular to mean that at least one component of at least one object is formed in one piece with at least one component of at least one further object. The term “in one piece” shall be understood in particular to mean connected at least by a substance-to-substance bond, for example by a welding process, an adhesive process, an injection moulding process, and/or another process appearing expedient to a person skilled in the art. The term “in one piece” shall advantageously also be understood to mean “in one part”. The term “in one part” shall be understood in particular to mean formed in a single piece, for example by production from a casting and/or by production in a one-component or multi-component injection moulding method advantageously from an individual blank, and particularly preferably in a spinning method, in particular a wet spinning method, such as reactive spinning, in which the filter unit is produced with integrated adsorbent in particular in a phase inversion process.

A “filter unit” shall be understood in particular to mean a membrane filter unit provided for cleaning micro-pollutants from water by retaining the micro-pollutants at pores of the filter membrane. The filter unit in particular comprises at least one filter element, preferably at least 5 filter elements, preferably at least 10 filter elements, and particularly preferably at least 20 filter elements. The filter element is formed in particular as a filter membrane and advantageously as a hollow-fibre filter membrane, in which a wall of the filter element forms the membrane and defines a hollow channel. In principle, the filter element can perform a cleaning of water guided in the hollow channel as the water passes from the closed hollow channel through the filter element into an external space, such that water leaving the hollow channel is cleaned, or the filter element can preferably perform a cleaning of water entering the hollow channel from the external space, the water then being guided in the cleaned state in the hollow channel.

In order to achieve continuous adsorption and in order to avoid contamination of the water between the non-specific adsorption element and the specific adsorption element, it is proposed that the non-specific adsorption element and the specific adsorption element are in contact with one another at least in part. The non-specific adsorption element and the specific adsorption element are in particular directly adjacent to one another. The same flow profile is advantageously flowed through the non-specific adsorption element and the specific adsorption element in an operating state, at least substantially at the same time.

It is also proposed that the non-specific adsorption element and the specific adsorption element are arranged at least partially within one another. Here, at least one of the adsorption elements can be formed as a carrier for the other adsorption element. The non-specific and the specific adsorption element are preferably mixed with one another, in particular mixed homogeneously with one another. In particular, non-specific adsorption and specific adsorption can be performed simultaneously hereby. The homogeneity of the non-specific adsorption and of the specific adsorption preferably can be improved.

In a preferred embodiment of the invention, it is proposed that the adsorption element consists of the non-specific adsorption element to an extent of at least 10% and at most 98%. The adsorption element advantageously consists of the specific adsorption element to an extent of at least 2% and at most 90%. The adsorption unit can additionally consist, in particular at least in part, of a strengthening agent, which is preferably provided for stabilising the adsorption unit, in particular at the time of production of the adsorption unit. The adsorption unit is particularly preferably formed fully by the specific adsorption element and the non-specific adsorption element. The proportions of the specific adsorption element and the non-specific adsorption element are advantageously selected such that they add up to give 100% of the adsorption unit. If, for example, the adsorption unit consists to a proportion of 10% of the non-specific adsorption element, the adsorption unit thus consists of the specific adsorption element in particular to a proportion of 90%. The processing efficiency of the water processing device can hereby be further improved, since in particular the proportions of the non-specific adsorption element and of the specific adsorption element advantageously can be matched to a composition of the micro-pollutants contaminating the water to be processed.

It is also proposed that the adsorption unit comprises at least one adsorbent, which forms a main body of the adsorption unit at least to a large extent. The main body in particular forms a block and/or a fill of the adsorption unit at least to a large extent and is provided in particular as a carrier for the non-specific adsorption element and/or the specific adsorption element. The expression “at least to a large extent” shall be understood here to mean in particular more than 50%, advantageously more than 65%, preferably more than 75%, particularly preferably more than 85%, and particularly advantageously at least 95%. Production can be simplified hereby. A compact construction can also be attained.

It is also proposed that the non-specific adsorption element forms the main body at least in part. The main body is in particular formed by the non-specific adsorbent at least to a large extent and advantageously completely. In particular, the main body can be formed by the strengthening agent at least in part. The production can be further simplified hereby, since the main body can be used in a variable manner as a carrier for different specific adsorbents of the specific adsorption element.

In a preferred embodiment of the invention, it is proposed that the non-specific adsorption element comprises at least one organic adsorbent. In particular, the organic adsorbent is activated carbon, preferably granulated activated carbon, and particularly preferably sintered granulated activated carbon. It is conceivable in particular that the activated carbon is present in the form of fibres that in particular are intertwined with one another, preferably interwoven. The organic adsorbent in particular forms the main body at least in part, preferably at least to a large extent, and particularly preferably completely. The non-specific adsorption element can also comprise a plurality of preferably different organic adsorbents. Production costs can be saved hereby.

It is also proposed that the non-specific adsorption element comprises at least one mineral adsorbent. The mineral adsorbent preferably forms the non-specific adsorption element to an extent of from 5% to 20%. The mineral adsorbent is in particular bentonite, diatomaceous earth, silica gel, alumina and/or zinc oxide. The non-specific adsorption element can also comprise a plurality of mineral adsorbents. The processing efficiency can be further improved hereby. Furthermore, costs can be kept low, since the proportion of mineral adsorbent can be kept small.

In order to improve in particular the specific adsorption of medicaments, it is proposed that the specific adsorption element comprises at least one reversed-phase adsorbent. A “reversed-phase adsorbent” is to be understood in particular to mean an advantageously cross-linked, functionalised organic polymer, such as ethylvinylbenzene, which in particular comprises functionalised ligands. The ligand can advantageously be provided for hydrophobic functionalisation. The specific adsorption element can comprise in particular a plurality of reversed-phase adsorbents, preferably having different properties, in particular different functional groups, which are provided specifically for adsorption with at least one micro-pollutant, in particular precisely one micro-pollutant.

In order to improve in particular a specific adsorption of heavy metals and advantageously metals contained in industrial chemicals, medicaments and/or pesticides, it is proposed that the specific adsorption element comprises at least one ion exchanger adsorbent. An “ion exchanger adsorbent” shall be understood in particular to mean a specific adsorbent, which preferably uses Coulomb interactions as adsorption principle and is provided in particular for adsorbing and/or exchanging ions of a micro-pollutant, which in particular is dissolved in the liquid. The ion exchanger adsorbent can advantageously be formed as a cation exchanger adsorbent and/or anion exchanger adsorbent. The ion exchanger adsorbent is in particular a functionalised hydrophilic polymer, such as a functionalised silica gel, a functionalised cellulose and/or a functionalised dextran. The function of the specific adsorbent as anion and/or cation exchanger adsorbent is in particular dependent on the functionalisation. Ammonium groups, preferably quaternary ammonium groups, diethylaminoethyl (DEAE), trimethylhydroxypropyl (QA), quaternary aminoethyl (QAE), quaternary aminomethyl (Q), triethylaminomethyl (TEAE), triethylaminopropyl (TEAP) and polyethyleneimine (PEI) can be used in particular for functionalisation of the specific adsorbent as an anion exchanger adsorbent. Carboxyl groups, sulfate groups, in particular sulfonate (S), sulfoethyl (SE), sulfopropyl (SP), phosphate groups, in particular orthophosphate (P), methacrylate and/or carboxymethyl (CM), can be used advantageously in particular for functionalisation of the specific adsorbent as cation exchanger adsorbent. The ion exchanger adsorbent particularly preferably comprises at least one functionalised agarose. In particular, the agarose is formed as a cross-linked agarose, more specifically in particular as sepharose, preferably as sepharose pellets, in particular also known as sepharose beads. The agarose is particularly preferably functionalised by means of an ammonium group, preferably a quaternary ammonium group, and particularly preferably diethylaminoethyl (DEAE). The specific adsorbent is preferably formed as an anion exchanger adsorbent. The specific adsorption element can also comprise in particular a plurality of, preferably different, ion exchanger adsorbents.

It is also proposed that the specific adsorption element comprises at least one adsorbent which is provided for adsorption by means of hydrogen bridges. The specific adsorption element preferably comprises linear and in particular cross-linked polyvinylpyrrolidone (PVPP) and/or copolymers thereof, such as vinylpyrrolidone/vinyl acetate, in particular in different molecular weights and degrees of cross-linking. An environmental and/or health compatibility can be further improved hereby. The specific adsorption element can also comprise in particular a plurality of, preferably different, adsorbents, which are provided for adsorption by means of hydrogen bridges. A specific adsorption of proteins occurring in medicaments can preferably be improved hereby.

In a particularly preferred embodiment of the invention, it is proposed that the specific adsorption element comprises at least one complexing agent adsorbent. A complexing agent adsorbent shall be understood in particular to mean a substance which comprises at least one charged ligand, preferably a plurality of charged ligands, in particular carboxyl groups, which adsorb and in particular bind at least one charged micro-pollutant, preferably a heavy metal ion. During the adsorption, the complexing agent adsorbent and the micro-pollutant in particular form a chelate complex. The complexing agent adsorbent can be ethylenediaminetetraacetic acid (EDTA) in particular. The specific adsorption element can also comprise in particular a plurality of, preferably different, complexing agent adsorbents. In particular, a specific adsorption of heavy metals and advantageously metals contained in industrial chemicals, medicaments and/or pesticides can be further improved hereby.

A system is also proposed, comprising a water processing device and comprising at least one pre-filtration unit arranged upstream of the water processing device in respect of the direction of flow. The pre-filtration unit is preferably arranged such that all water reaching the water processing device has passed through the pre-filtration unit prior to entering the water processing device. A “pre-filtration unit” is to be understood in particular to mean a unit that is provided for removing contaminants having particles which in particular are larger than micro-pollutants removed in the water processing device, in particular having a size of greater than 0.01 μm, preferably greater than 0.1 μm, preferably greater than 1 μm, and particularly preferably greater than 10 μm, in order to prevent a clogging of the water processing device. In particular, a system for water purification that has improved processing efficiency can be provided.

The water processing device is not intended to be limited here to the above-described application and embodiment. In particular, the water processing device, in order to comply with the operating principle described herein, can have a number of individual elements, components and units differing from the number stated herein. In addition, values lying within the stated limits are also considered to be disclosed and arbitrarily selectable from the value ranges specified in this disclosure.

### BRIEF DESCRIPTION OF THE SEVERAL VIEWS OF THE DRAWING(S)

Further advantages will become clear from the following description of the drawings. The drawings show exemplary embodiments of the invention. The drawings, the description, and the claims contain numerous features in combination. A person skilled in the art will also expediently consider the features individually and combine them to form useful further combinations.

In the drawings:

FIG. 1 shows a water processing cartridge with a water processing device in a sectional view,

FIG. 2 shows a cartridge of the water processing device in an exploded view,

FIG. 3 shows part of the water processing device in an exploded view,

FIG. 4 shows part of a filter unit of the water processing device in a perspective view,

FIG. 5 shows part of an adsorption unit of the water processing device in a schematic sectional view,

FIG. 6 shows a system with a water processing device and a pre-filtration unit in a schematic sectional view,

FIG. 7 shows a further water processing device in a sectional view,

FIG. 8 shows an alternative water processing device in a sectional view, and

FIG. 9 shows a further alternative water processing device in a sectional view.

### DETAILED DESCRIPTION OF THE INVENTION

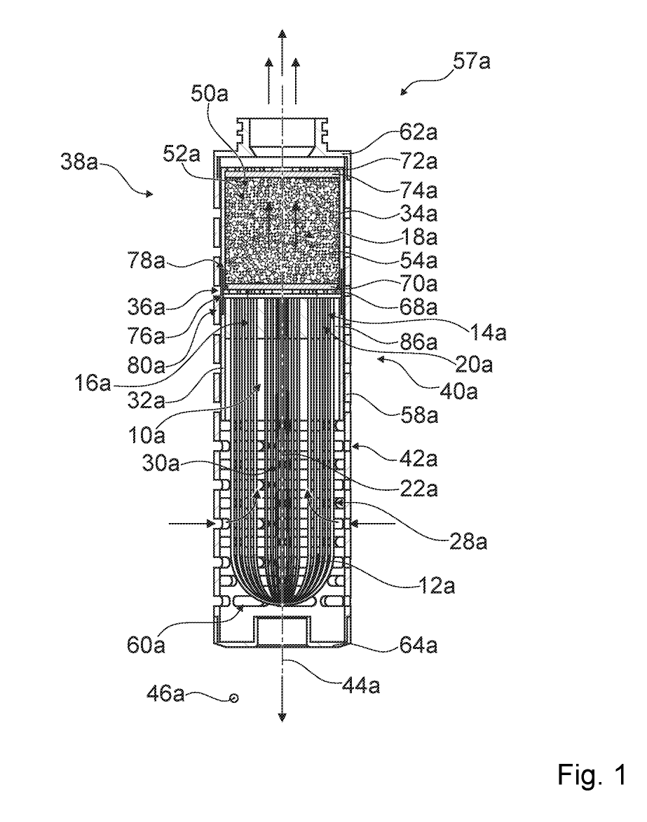

FIG. 1 shows a water processing cartridge 57a with a water processing device in a sectional view. The water processing device is provided for removing micro-pollutants, in particular medicaments, from water, in particular drinking water. To this end, the water processing cartridge 57a is provided for installation in a system for processing water.

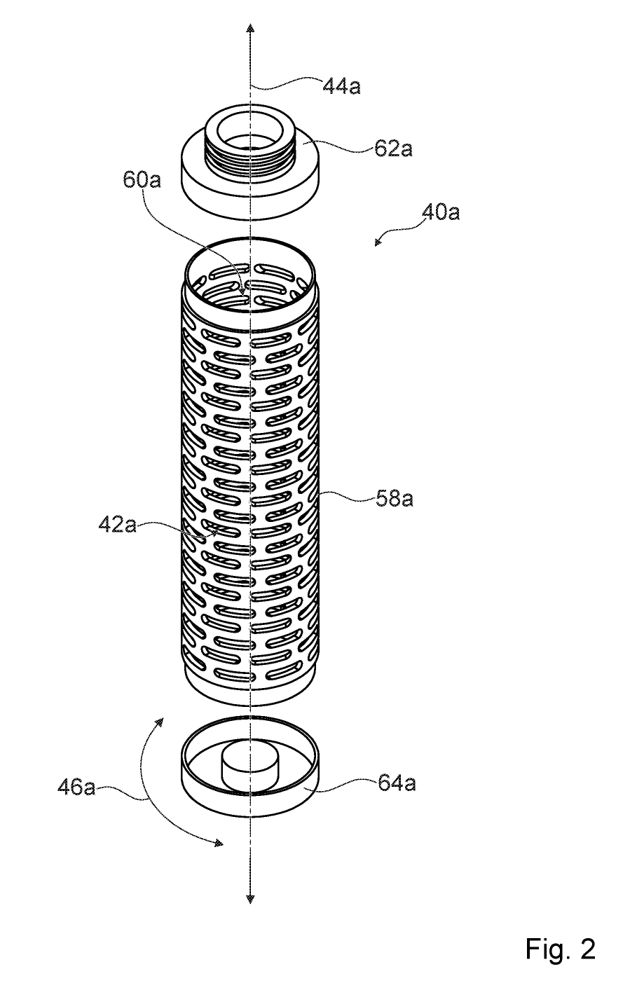

FIG. 2 shows a cartridge 40a of the water processing device. The cartridge 40a is formed to be tubular. The cartridge 40a comprises a cylinder jacket 58a. The cylinder jacket 58a defines, in its interior, a receiving space 60a. The receiving space 60a is used to accommodate further units of the water processing device. The cartridge 40a comprises openings 42a, which are arranged offset relative to one another in the peripheral direction 46a, as considered in the axial direction 44a. The openings 42a are formed by cut-outs, in particular cut-outs perpendicular to the axial direction 44a, in the cylinder jacket 58a. The cartridge 40a comprises a cartridge connector 62a. The cartridge connector 62a is provided for connecting the water processing device to a water pipeline. The cartridge connector 62a comprises a screw thread for connection of the water processing device. The cartridge connector 62a closes the cylinder jacket 58a from one side, in particular in the axial direction 44a. The cartridge 40a also comprises a cartridge termination 64a. The cartridge termination 64a closes the cylinder jacket 58a from a further side, in particular in the axial direction 44a. The cartridge 40a is formed from a plastics material. The cartridge 40a is advantageously formed from polypropylene, more specifically particularly preferably from a polypropylene homopolymer (PP-H).

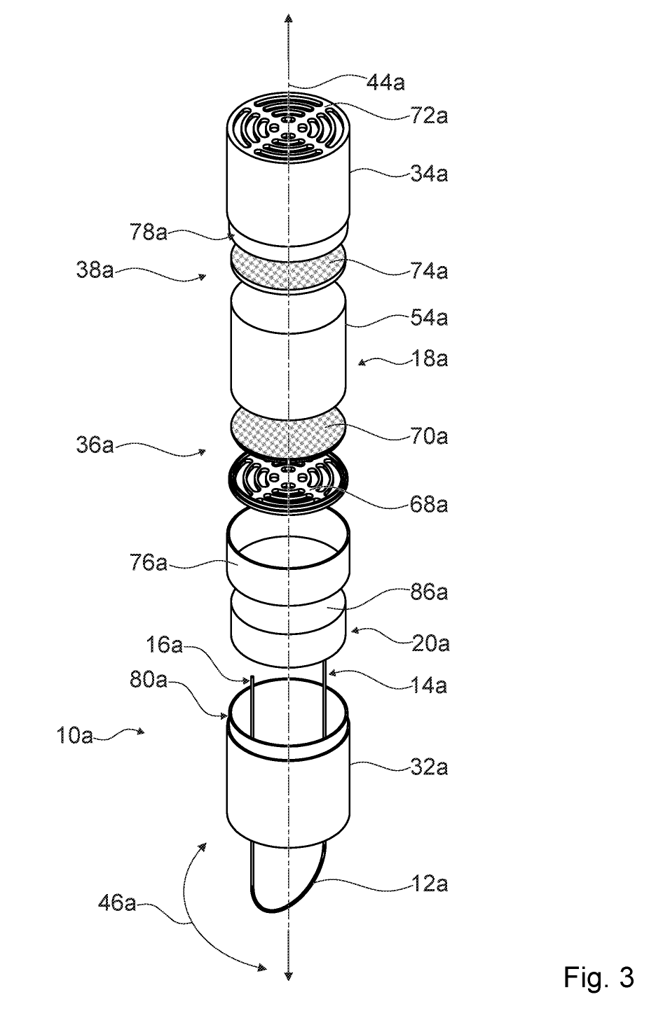

FIG. 3 shows an exploded view of part of the water processing device. The water processing device comprises a filter housing 32a. The filter housing 32a, when in the assembled state, is arranged in the receiving space 60a of the cartridge 40a. A filter unit 10a of the water processing device is arranged at least partially in the filter housing 32a. The filter unit 10a is arranged within the filter housing 32a to an extent of less than 50%, as considered in the main direction of extent of the filter unit 10a. The filter housing 32a is formed as a hollow cylinder. The filter housing 32a comprises a cylinder jacket, which at least partially surrounds a holding element 20a of the water processing device. The water processing device also comprises an adsorption housing 34a. The adsorption housing 34a, when in the assmbled state, is arranged in the receiving space 60a of the cartridge 40a. An adsorption unit 18a of the water processing device is arranged in the adsorption housing 34a. The adsorption housing 34a is formed as a hollow cylinder. The adsorption housing 34a comprises a cylinder jacket, which at least partially surrounds the adsorption unit 18a. In an operating state in which water is flowed through the water processing device, the filter housing 32a is arranged upstream of the adsorption housing 34a as considered in the flow direction.

The water processing device comprises a screen unit 38a. The screen unit 38a separates the filter housing 32a and the adsorption housing 34a from one another. The screen unit 38a also at least partially closes the adsorption housing 34a from at least one side. The screen unit 38a comprises the screen cover 68a. The screen cover 68a at least partially closes the adsorption unit from one side. The screen cover 68a also separates the adsorption unit 18a from the filter unit 10a. The screen cover 68a is connected to the adsorption housing 34a with positive engagement. The screen cover 68a could also be connected to the adsorption housing 34a in a force-locking manner and/or with a substance-to-substance bond. Alternatively or additionally, the screen cover 68a can be formed in one piece with the adsorption housing 34a. The screen cover 68a comprises a plurality of through-openings. The through-openings are provided for enabling a flow of water between the filter unit 10a and the adsorption unit 18a.

The screen unit 38a comprises at least one frit 70a. The frit 70a is in the form of a disc. The frit 70a is produced from a porous material. The frit 70a is produced from a cross-linked polyethylene. The frit 70a is arranged on a side of the screen unit 38a facing towards the adsorption unit 18a. The frit 70 is arranged in the adsorption housing 34a. The frit 70a is arranged after the screen cover 68a and in particular before the adsorption unit 18a, as considered in the direction of flow. The frit 70a is provided for preventing contamination of the adsorption unit 18a and preferably for preventing the adsorption unit 18a from escaping at least in part from the adsorption housing 34a.

The screen unit 38a comprises a further screen cover 72a. The further screen cover 72a is formed at least substantially equivalently to the screen cover 68a. The further screen cover 72a is formed in one piece with the adsorption housing 34a. It is conceivable that the further screen cover 72a is formed separately from the adsorption housing 34a and in particular is connected thereto in a force- and/or positively-locking manner. The further screen cover 72a closes the adsorption housing 34a at least partially from at least one further side. The further screen cover 72a is arranged after the adsorption unit 18a as considered in the direction of flow. The screen unit 38a also comprises a further frit 74a. The further frit 74a is formed at least substantially equivalently to the first frit 70a. The further frit 74a is arranged in the adsorption housing 34a. The further frit 74a is arranged after the adsorption unit 18a and in particular before the further screen cover 72a, as considered in the direction of flow.

The water processing device comprises a connection unit 36a. The connection unit 36a, in the assmbled state, connects the adsorption housing 34a and the filter housing 32a to one another, in particular with positive engagement. Alternatively or additionally, the connection unit 36a can also be provided for a force-locking connection and/or a substance-to-substance bond. For example, it is conceivable that the connection unit 36a comprises a thread for an additional force-locking connection. The connection unit 36a comprises at least one connection element 76a, which, in the assmbled state, connects the filter housing 32a to the adsorption housing 34a. The connection element 76a is formed separately from the adsorption housing 34a and/or the filter housing 32a. Alternatively or additionally, the connection element 76a can be formed at least partially in one piece with the filter housing 32a and/or the adsorption housing 34a. The connection element 76a is formed as a sleeve.

The connection unit 36a comprises at least one connection element receptacle 78a, which is provided for receiving the connection element 76a. The connection element receptacle 78a is formed correspondingly to the connection element 76a. The connection element receptacle 78a is formed as a recess in the adsorption housing 34a. The connection unit 36a comprises a further connection element receptacle 80a. The further connection element receptacle 80a is formed at least substantially equivalently to the connection element receptacle 78a. The further connection element receptacle 80a is formed as a recess in the filter housing 32a.

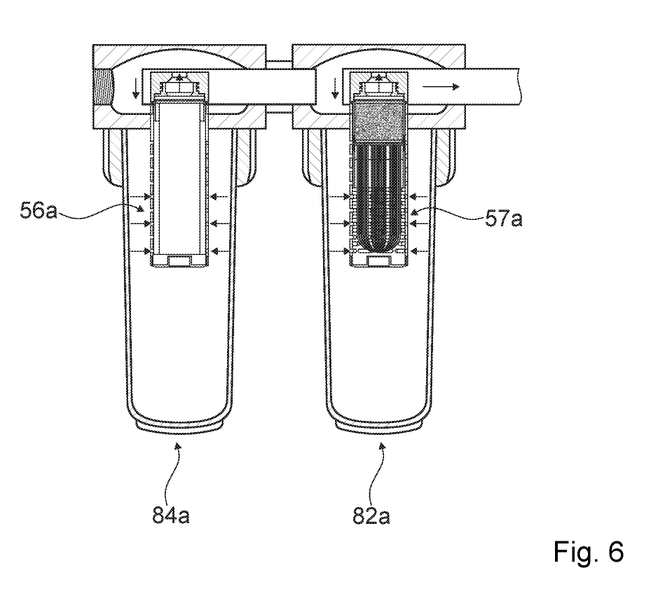

At the time of assembly of the water processing device, the further frit 74a is arranged in the adsorption housing 34a. The adsorption unit 18a is also arranged in the adsorption housing 34a, in particular after the further frit 70a as considered in the flow direction. The frit 70a is arranged in the adsorption housing 34a, in particular after the adsorption unit 18a as considered in the flow direction. The screen cover 68a closes the adsorption housing 34a. The filter unit 10a is arranged in the filter housing 32a. The filter housing 32a is arranged after the adsorption housing 34a as considered in the flow direction. The connection unit 36a connects the adsorption housing 34a and the filter housing 32a. The connection element 76a engages in the connection element receptacle 78a. The connection element 76a engages in the further connection element receptacle 80a. The filter housing 32a and the adsorption housing 34a are arranged in the receiving space 60a of the cartridge 40a. The cylinder jacket 58a is closed by the cartridge termination 64a. The cylinder jacket 58a is also connected to the cartridge connector 62a. The cartridge 40a can also be arranged in a superior housing 82a (see FIG. 6).

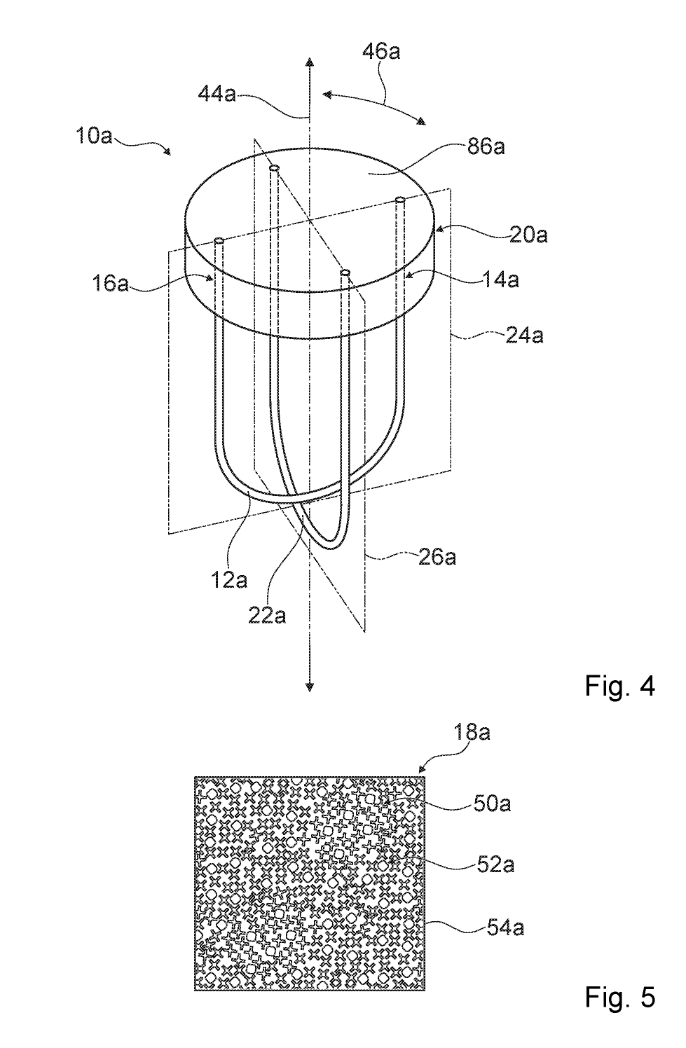

Part of the filter unit 10a is shown schematically in FIG. 4. The filter unit 10a is provided for at least one filtering of the water in an operating state of the water processing device. The filter unit 10a is formed as a membrane filter unit. The filter unit 10a comprises at least one filter element 12a. The filter unit 10a comprises in particular a multiplicity of filter elements 12a, 22a, wherein only two filter elements 12a, 22a equivalent to one another have been illustrated in FIG. 4 for the sake of clarity. The filter element 12a is tubular. The filter element 12a is formed as a filter membrane. The filter membrane is a hollow-fibre filter membrane. The filter element 12a comprises a wall. The wall forms the filter membrane. The wall defines a hollow channel of the filter element 12a. The filter element 12a comprises a first end portion 14a and a second end portion 16a. The end portions 14a, 16a extend along the filter element 12 over at most 5 cm. The end portions 14a, 16a are arranged fixedly relative to one another by means of the holding element 20a of the water processing device. The end portions 14a, 16a of the filter element 12a are fixedly connected to the holding element 20a. The holding element 20a is formed as a flat block. The holding element 20a is connected to the filter housing 32a by a substance-to-substance bond. The holding element 20a is advantageously formed from a binder 86a. The binder 86a is an epoxy resin. It is conceivable that another binder 86a can be used, for example an adhesive and/or a plastics material. The end portions 14a, 16a are sealed off prior to assembly of the filter element 12a, in such a way that the binder 86a does not contaminate the filter element 12a, in particular the wall of the filter element 12a. At the time of assembly, the filter housing 32a is filled with the binder 86a. The end portions 14a, 16a of the filter element 12a are arranged in the binder 86a, which is still liquid. The binder 86a is cured to form the holding element 20a. The cured binder 86a is also ground in such a way that openings in the end portions 14a, 16a of the filter element 12a are exposed.

The filter element 12a is bent at least in portions in the assembled state and in particular has a loop shape. The filter element 12a is bent in such a way that the end portions 14a, 16a of the filter element 12a enclose an inner angle of from 0° to 90°. In the present case the end portions 14a, 16a are at least substantially parallel or preferably antiparallel to one another, such that the filter element 12a is preferably bent in a U shape. In the present case, the inner angle is consequently approximately 0°. The filter element 12a in particular has a plane of main extent 24a. The filter element 12a is intersected by the plane of main extent 24a over the entire extent of the filter element 12a.

The filter unit 10a also comprises at least one further filter element 22a. A further filter element 22a is formed at least substantially equivalently to the filter element 12a, in particular is shaped equivalently thereto and is advantageously fastened equivalently to the holding element 20a. The filter element 12a and the further filter element 22a differ from one another by a length. The further filter element 22a surrounds the filter element 12a at least in part. The further filter element 22a has a further plane of main extent 26a. In the assembled state, the further plane of main extent 26a of the further filter element 22a is different from the plane of main extent 24a of the filter element 12a. The plane of main extent 24a of the filter element 12a and the further plane of main extent 26a of the further filter element 22a are arranged at an angle to one another. In the present case, the plane of main extent 24a of the filter element 12a and the further plane of main extent 26a of the further filter element 22a are at least substantially perpendicular to one another. The planes of main extent 24a, 26a can also be arranged at a different angle to one another, in particular from 20° to 160°, or alternatively can be arranged at least substantially parallel to one another.

The filter unit 10a also comprises a group 28a (see FIG. 2) of filter elements 12a. The group 28a of filter elements 12a comprises at least one additional filter element 12a, in particular a plurality of additional filter elements 12a, which is/are formed at least substantially equivalently to the filter element 12a. The filter elements 12a of the group 28a are in particular bundled by means of a mesh of the water processing device. The filter unit 10a also comprises a further group 30a (see FIG. 2) of further filter elements 22a. The further group 30a of further filter elements 22a comprises at least one additional further filter element 22a, in particular a plurality of additional further filter elements 22a, which is/are at least substantially equivalent to the further filter element 22a. The filter elements 22a of the group 30a are bundled in particular by means of a further mesh of the water processing device. Alternatively or additionally, the filter unit 10a can comprise just one of the groups 28a, 30a or additional groups.

In FIG. 5 the adsorption unit 18a is shown schematically in a sectional view. The adsorption unit 18a comprises a non-specific adsorption element 50a. The adsorption unit 18a can consist of the non-specific adsorption element 50a to an extent of at least 10% and at most 98%. In the present case, the adsorption unit 18a consists of the non-specific adsorption element 50a to an extent of 80%. In particular, the adsorption unit 18a can also consist of the non-specific adsorption element 50a to an extent of further values from 10% to 98%.

The non-specific adsorption element 50a comprises at least one organic adsorbent. In the present case, the organic adsorbent is activated carbon. The organic adsorbent is present here in the form of a cylindrical block. The organic adsorbent is activated carbon, in particular sintered granulated activated carbon. Alternatively or additionally, the organic adsorbent can be present in the form of a fill, in particular in granulated form. The non-specific adsorption element 50a comprises a main body 54a. The main body 54a forms the adsorption unit 18a to a large extent. The adsorption unit 18a comprises an adsorbent, which forms the main body 54a of the adsorption unit 18a at least in part. In the present case, the organic adsorbent forms the main body 54a at least in part. Alternatively, the organic adsorbent can form the main body 54a completely.

The non-specific adsorption element 50a also comprises at least one mineral adsorbent. The non-specific adsorption element 50a at least comprises the mineral adsorbent to an extent of 5% to 20%. In the present case, the non-specific adsorption element 50a comprises a mineral adsorbent to an extent of 5%. In the present case, the mineral adsorbent is bentonite. The mineral adsorbent also forms the main body 54a of the non-specific adsorption element 50a at least in part. Alternatively or additionally, the non-specific adsorption element 50a can comprise diatomaceous earth, silica gel, alumina and/or zinc oxide as mineral adsorbent.

The adsorption unit 18a comprises a specific adsorption element 52a. The adsorption unit 18a can consist of the specific adsorption element 52a to an extent of at least 2% and at most 90%. In the present case, the adsorption unit 18a consists of the specific adsorption element 52a to an extent of 20%. In particular, the adsorption unit 18a can also consist of the specific adsorption element 52a to an extent of further values of from 2% to 90%. The specific adsorption element 52a comprises at least one specific adsorbent. Alternatively or additionally, the main body 54a of the adsorption unit 18a can be formed at least in part of a specific adsorbent.

The specific adsorption element 52a comprises at least one reversed-phase adsorbent, such as a cross-linked, functionalised organic polymer. The specific adsorption element 52a preferably comprises a cross-linked ethylvinylbenzene as reversed-phase adsorbent. The specific adsorption element 52a further comprises at least one ion exchanger adsorbent. The ion exchanger adsorbent can be formed as a cation exchanger or anion exchanger. In the present case, the ion exchanger adsorbent is formed as an anion exchanger. The ion exchanger adsorbent is an agarose, which is functionalised by means of an ammonium group, preferably a quaternary ammonium group, and particularly preferably diethylaminoethyl (DEAE). The specific adsorption element 52a also comprises at least one adsorbent, which is provided for adsorption by means of hydrogen bridges. In the present case, the adsorbent which is provided for adsorption by means of hydrogen bridges is linear and/or cross-linked polyvinylpyrrolidone (PVPP). The specific adsorption element 52a also comprises at least one complexing agent adsorbent. In the present case, the complexing agent adsorbent is ethylenediaminetetraacetic acid (EDTA). Alternatively or additionally, the specific adsorbent 52a can comprise further specific adsorbents.

The non-specific adsorption element 50a and the specific adsorption element 52a are at least partially in contact with one another. The non-specific adsorption element 50a and the specific adsorption element 52a are arranged at least partially within one another and in particular are mixed with one another.

In an operating state, water that is to be cleaned is flowed through the water processing device fully (see FIG. 1). The direction in which the water enters the water processing device is in particular at least substantially perpendicular to a direction in which the water leaves the water processing device. The water enters the water processing device through the openings in the cartridge 40a, in particular at least substantially perpendicularly to the axial direction 44a. The water also enters the filter unit 10a at least substantially perpendicularly to the axial direction 44a. The water passes through the filter element 12a, in particular the wall of the filter element 12a, at least in part. The water is filtered by means of the wall. The water collects inside the filter element 12a, in particular in the hollow channel. The hollow channel guides the water in the direction of the adsorption unit 18a. The water penetrates the adsorption unit 18a, in particular in the axial direction 44a. Micro-pollutants contained in the water are adsorbed by the adsorption unit 18a. The water leaves the water processing device through the cartridge connector 62a, in particular in the axial direction 44a.

FIG. 6 shows a system with the water processing device and with a pre-filtration unit 56a. The pre-filtration unit 56a is arranged upstream of the water processing device in respect of the flow direction. The system is provided for installation in a water pipeline. The pre-filtration unit 56a is formed as a microfiltration unit with a filter membrane and is provided for retaining coarse dirt particles measuring at least 5 μm in size. In alternative embodiments, filter membranes can be used which are suitable for retaining coarse dirt particles having other sizes, for example 20 μm. The micro-pollutants are then removed in the water processing device.

The water processing device is arranged in the superior housing 82a. The superior housing 82a comprises an outlet with a screw thread for connection to a water pipeline. The pre-filtration unit 56a is arranged in a further superior housing 84a. The further superior housing 84a comprises a connector with screw thread for connection to a water pipeline. The pre-filtration unit 56a and the water processing device are arranged relative to one another such that water which enters the further superior housing 84a firstly passes through the pre-filtration unit 56a and then passes into the superior housing 82a, in which the water is processed by means of the water processing device.

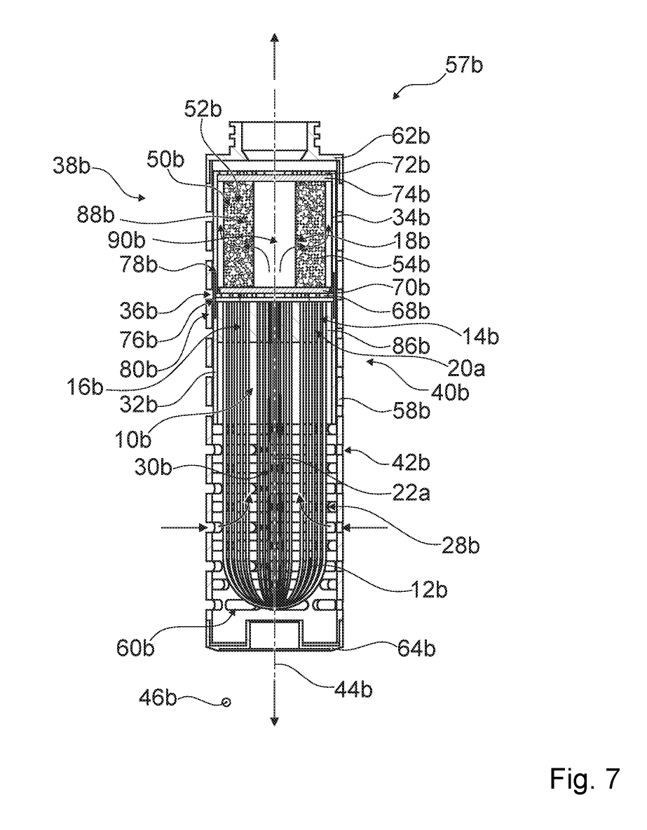

Further exemplary embodiments of the invention are shown in FIGS. 7 to 9. The following descriptions and the drawings are limited fundamentally to the differences between exemplary embodiments, wherein reference can also be made in principle to the drawings and/or the description of the other exemplary embodiments, in particular FIGS. 1 to 6, in respect of similarly denoted components, in particular in respect of components having like reference signs. For distinction among the exemplary embodiments, the letter ‘a’ follows the reference signs of the exemplary embodiment in FIGS. 1 to 6. The letter ‘a’ is replaced by the letters ‘b’ to ‘d’ in FIGS. 7 to 9.

FIG. 7 shows a further water processing device. The exemplary embodiment of FIG. 7 differs from the previous exemplary embodiment at least fundamentally by an adsorption unit 18b of the water processing device. In the present case the adsorption unit 18b is at least substantially tubular. The adsorption unit 18b has a tube wall 88b. The tube wall 88b defines a tube channel 90b. In the operating state, the water to be processed penetrates the adsorption unit 18b at least substantially perpendicularly to an axial direction 44b. The water is guided from a filter unit 10b in the axial direction 44b into the tube channel 90. The tube channel 90b is closed at one end, such that the water penetrates the tube wall 88b of the adsorption unit 18b at least substantially perpendicularly to the axial direction 44b. Once the water has passed through the tube wall 88b, it enters an adsorption housing 34b. The adsorption housing 34b diverts the water in the axial direction 44b.

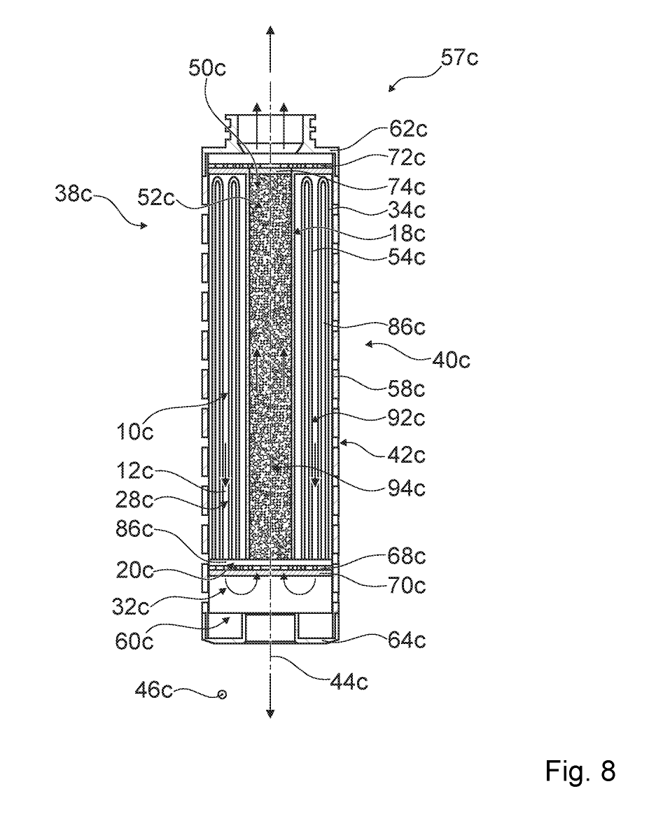

FIG. 8 shows an alternative water processing device. The exemplary embodiment of FIG. 8 differs from the previous exemplary embodiments at least fundamentally in that a filter unit 10c of the water processing device is tubular. The filter unit 10c comprises a tube wall 92c. The tube wall 92c is formed at least partially by a group 28c of filter elements 12c of the filter unit 10c. The filter elements 12c are arranged in a circle. A holding element 20c of the water processing device, in which the filter elements 12c are arranged, is formed as a circular disc. The circular disc has an opening. The tube wall 92c defines a tube channel 94c. An adsorption housing 34c of the water processing device is arranged within the tube channel 94c. A filter housing 32c, in which the filter unit 10c is arranged at least in part, is closed in the axial direction 44c. If water, in an operating state, leaves the filter elements 12c in the axial direction 44c, the water is diverted in the reverse direction by the filter housing 32c. The water enters the adsorption housing 34c, in particular in the axial direction 44c, through the opening in a holding element 20c.

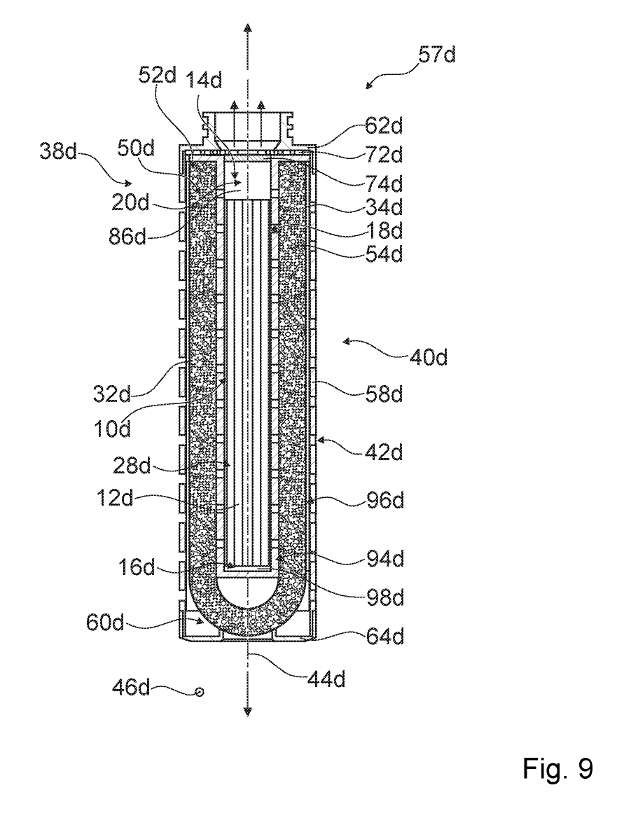

FIG. 9 shows a further alternative water processing device. The exemplary embodiment of FIG. 9 differs from the previous exemplary embodiments at least substantially in that an adsorption unit 18d of the water processing device is arranged upstream of a filter unit 10d of the water processing device in respect of the direction of flow. In the present case, the water processing device comprises a flexible adsorption casing 96d instead of an adsorption housing. The adsorption casing 96d is in particular formed as a tubular bag. The adsorption casing 96d is formed from a material such as a nonwoven fabric. The adsorption unit 18d of the water processing device is arranged within the adsorption casing 96d. In the present case, the adsorption casing 96d also surrounds a filter housing 32d of the water processing device. In the present case the filter housing 32d is water-permeable perpendicularly to an axial direction 44d. The filter housing 32d serves as a spacer between the filter unit 10d and the adsorption unit 18d. The filter unit 10d comprises a group 28d of filter elements 12d. The filter elements 12d are straight. In the present case the water processing device comprises two holding elements 20d, 98d for end portions 14d, 16d of the filter elements 12d.

1. A water processing device which is provided for removing micro-pollutants from water, the device comprising at least one housing and at least one adsorption unit which is arranged in the housing and which adsorbs the micro-pollutants in at least one operating state and which comprises at least one non-specific adsorption element, wherein the adsorption unit comprises at least one specific adsorption element.

2. A water processing device according to claim 1, wherein the at least one non-specific adsorption element and the at least one specific adsorption element are in contact with one another.

3. A water processing device according to claim 1, wherein the at least one non-specific adsorption element and the at least one specific adsorption element are arranged within one another.

4. A water processing device according to claim 1, wherein the at least one adsorption unit comprises the at least one non-specific adsorption element to an extent of at least 10% and at most 98%.

5. A water processing device according to claim 1, wherein the at least one adsorption unit consists of comprises the at least one specific adsorption element to an extent of at least of 2% and at most 90%.

6. A water processing device according to claim 1, wherein the at least one adsorption unit comprises at least one adsorbent which forms a main body of the at least one adsorption unit.

7. A water processing device according to claim 6, wherein the at least one non-specific adsorption element comprises the main body.

8. A water processing device according to claim 1, wherein the at least one non-specific adsorption element comprises at least one organic adsorbent.

9. A water processing device according to claim 1, wherein the at least one non-specific adsorption element comprises at least one mineral adsorbent.

10. A water processing device according to claim 1, wherein the at least one specific adsorption element comprises at least one reversed-phase adsorbent.

11. A water processing device according to claim 1, wherein the at least one specific adsorption element comprises at least one ion exchanger adsorbent.

12. A water processing device according to claim 1, wherein the at least one specific adsorption element comprises at least one adsorbent which is provided for adsorption by hydrogen bridges.

13. A water processing device according to claim 1, wherein the at least one specific adsorption element comprises at least one complexing agent adsorbent.

14. A system comprising the water processing device according to claim 1, and comprising at least one pre-filtration unit arranged upstream of the water processing device in respect of direction of flow.

15. The water processing device of claim 1, provided for removing medicaments from water.
